(19) United States
(12) Patent Application Publication
(10) Pub. No.: US 2006/0126235 A1
(43) Pub. Date: Jun. 15, 2006

(54) Lamp holder with ground fault circuit interrupter receptacle

(76) Inventors: Steve Campolo, Malverne, NY (US); Lawrence S. Leopold, Floral Park, NY (US); James Richter, Bethpage, NY (US); James A. Porter, Farmingdale, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/348,953

(22) Filed: Feb. 7, 2006

Related U.S. Application Data
(63) Continuation-in-part of application No. 11/093,211, filed on Mar. 30, 2005.
(60) Provisional application No. 60/559,912, filed on Apr. 6, 2004.

(51) Int. Cl. H02H 3/00

(52) U.S. Cl. 361/42

(57) ABSTRACT

A lamp holder body having a lamp socket and a ground fault circuit interrupter (GFCI) receptacle on different surfaces of said body. The lamp holder body can be mounted to a standard outlet box and can have a provision to accommodate a switch or a lamp socket having a pull-chain switch.

This application is a continuation-in part of application Ser. No. 11/093,211 filed Mar. 30, 2005 and of provisional application No. 60/559,912 filed on Apr. 6, 2004.

### BACKGROUND

1. Field of the Invention

The present invention relates to a ground fault current interrupter (GFCI) and lamp holder.

2. Description of the Related Art

A ground fault is an unintentional electric path between a source of current and a grounded surface. Ground faults can occur when current is leaking or escaping to an electrical ground. If a person's body provides a path to the ground for this leakage, the person could be injured, burned, shocked, or electrocuted.

In the home's wiring system, a GFCI can monitor electric current flowing to a load and sense any loss of current. When the current flowing to the load differs by a pre-selected amount from that returning, the GFCI can interrupt power to that load. The GFCI can be designed to interrupt the power to help prevent injury to a person.

A GFCI receptacle may be used in place of a standard duplex receptacle found throughout most homes and businesses. The GFCI can protect against ground faults to an electrical load plugged into the outlet. Many receptacle-type GFCI also can be installed to provided ground fault protection to other electrical outlets and loads further “down stream” in a branch circuit.

GFCI protection can be required for many locations including most outdoor receptacles, bathroom receptacle circuits, garage wall outlets, kitchen receptacles, and receptacles in crawl spaces and unfinished basements. Some locations where GFCIs are located also may be less finished than other locations in a house. These locations may not have extensive wiring and switches for lighting as may be prevalent in other more finished locations.

### SUMMARY OF THE INVENTION

A lamp holder having a lamp socket and a ground fault circuit interrupter (GFCI) receptacle mounted in a body that can be coupled to a wall mounted electrical outlet box. The lamp holder body includes an opening sized to accommodate the GFCI receptacle and at least one opening sized to accommodate the lamp socket. The opening for the lamp socket can be sized to accept a socket for a standard lamp including but not limited to an incandescent lamp or for a fluorescent lamp.

Some implementations of the disclosure have the advantage that a single installation can satisfy the need for illumination and GFCI protection in areas where a single installation is required or convenient such as a basement, kitchen, bathroom, garage, closet or crawl space.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest terms.

### BRIEF DESCRIPTION OF THE DRAWINGS

Other aspects, features and advantages of the present invention will become more apparent from the following detailed description, the appended claims and the accompanying drawings in which similar elements are given similar reference numerals.

FIG. 1 illustrates a top perspective view of a lamp holder body for receiving a GFCI and a lamp socket;

FIG. 2A illustrates a top perspective view of the lamp holder body of FIG. 1 including a GFCI receptacle and a lamp socket;

FIG. 2B illustrates a bottom perspective view of the lamp holder body of FIG. 1;

FIG. 3 illustrates a top perspective view of another embodiment of a lamp holder body for a GFCI and two lamp sockets; and

FIG. 4 illustrates a top perspective view of still another embodiment of a lamp holder body for a GFCI and a lamp socket.

### DETAILED DESCRIPTION OF THE INVENTION

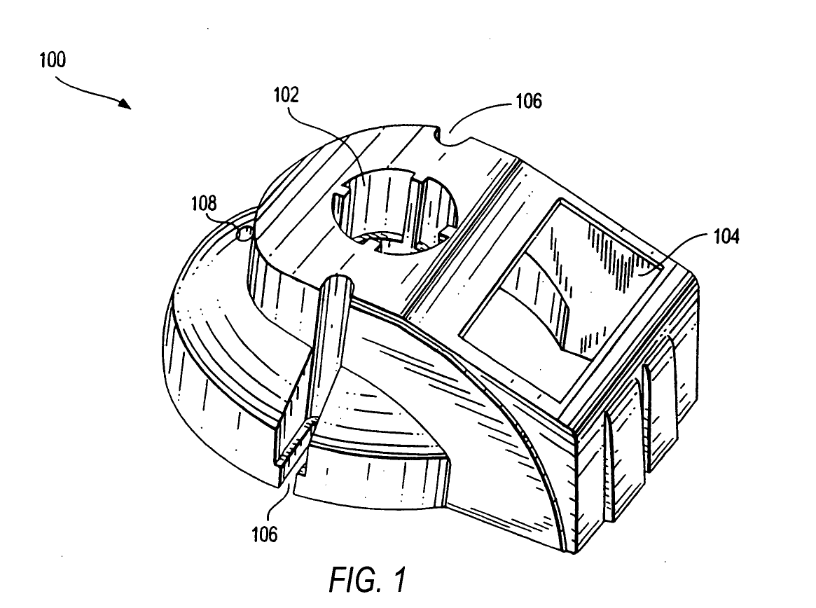

FIG. 1 is a top perspective view of a lamp holder body 100 for receiving a GFCI receptacle and a lamp socket in accordance with the present disclosure. The lamp holder body 100 has an opening 102 to receive a lamp socket and an opening 104 to receive a ground fault circuit interrupter (GFCI) receptacle. The lamp socket opening can be sized to receive a lamp socket that can accommodate various kinds of lamps including incandescent and fluorescent having an incandescent base or fluorescent base. The GFCI receptacle opening may have one or more receptacle mounting holes (not shown) to enable mounting the GFCI receptacle to the lamp holder body. The mounting holes for the receptacle can be threaded to receive a screw used to mount the receptacle to the lamp holder body. The lamp holder body also can include one or more mounting portions 104 positioned to enable mounting of the lamp holder body to a standard outlet box. The lamp holder body may be mounted to the outlet box using screws inserted through mounting portions of the lamp holder body and threaded into threaded portions of the outlet box. In an implementation, the lamp holder body 100 can include an opening 108 to accommodate an electrical switch. The switch (not shown) can be used to control the delivery of power to the lamp socket and/or the receptacle. Alternatively, the lamp socket can include a standard pull chain switch to control delivery of power to the lamp socket. Alternatively, delivery of power to the lamp socket and/or the receptacle can be from a separately located switch such as an occupancy sensor, photoelectric sensor or other sensor means.

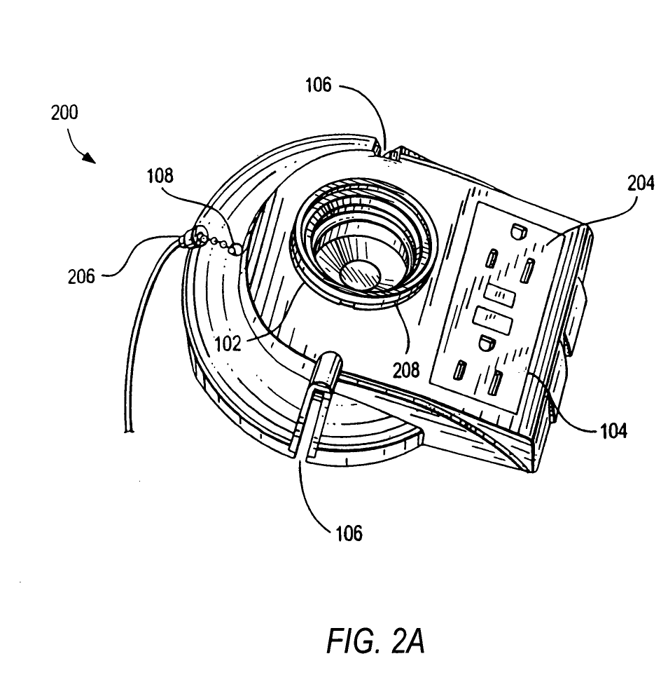

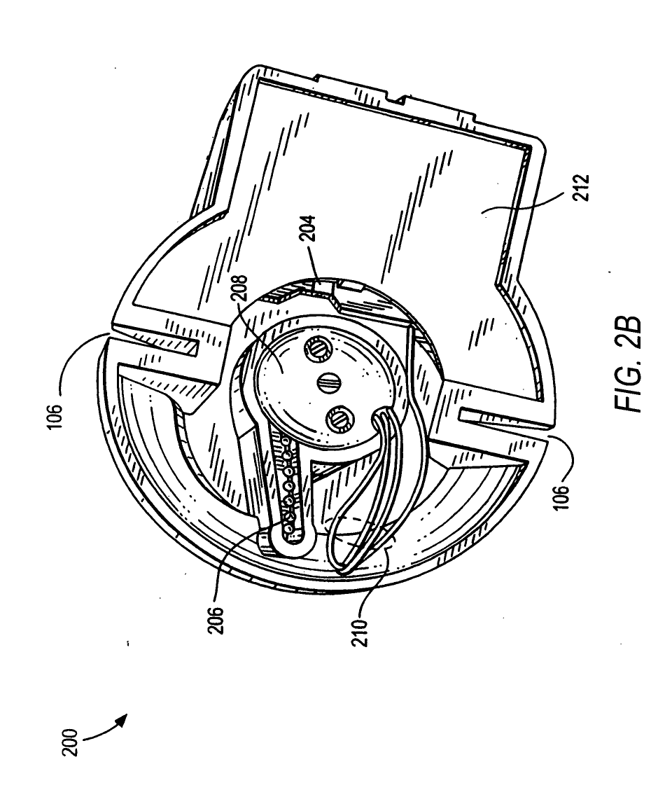

FIG. 2A illustrates a top perspective view of the lamp holder body 200 of FIG. 1 including a pull-chain switch 206, a lamp socket 208 and a GFCI receptacle 204. FIG. 2B illustrates a rear perspective of the lamp holder body 200 of FIG. 2A including the lamp socket 208 and GFCI receptacle 204. The lamp socket 208 is mounted in the lamp socket opening 102 and a GFCI receptacle 204 is mounted in the receptacle opening 104. Electrical wiring is generally shown as 210. Power from a household branch circuit can be wired directly to the GFCI receptacle 204. The GFCI receptacle also can be wired to monitor the current to the lamp socket 208 and/or downstream loads (not shown).

Alternatively, power may be supplied to the lamp socket 208 independently of the GFCI receptacle 204. In the embodiment illustrated, the lamp socket 208 has a pull-chain switch 206 to control power to the lamp socket 208. Alternatively, delivery of power to the lamp socket and/or the GFCI receptacle can be from a switch separate from the lamp socket. A back cover 212 made of an insulating material, such as plastic, can cover all or selected portions of the back of the lamp holder. The back cover 212 can provide protection for wiring and electrical connections in portions of the lamp holder that extend past an outlet box (not shown) mounted in the wall. In an implementation, a separate switch may be installed in the switch opening 108. The switch can be wired in series with the power from the household branch circuit to control power to the GFCI receptacle and/or lamp socket. Once the wiring is completed, the lamp holder body 200 can be mounted to an outlet box by screws inserted through the mounting portions 106 and threaded into the outlet box.

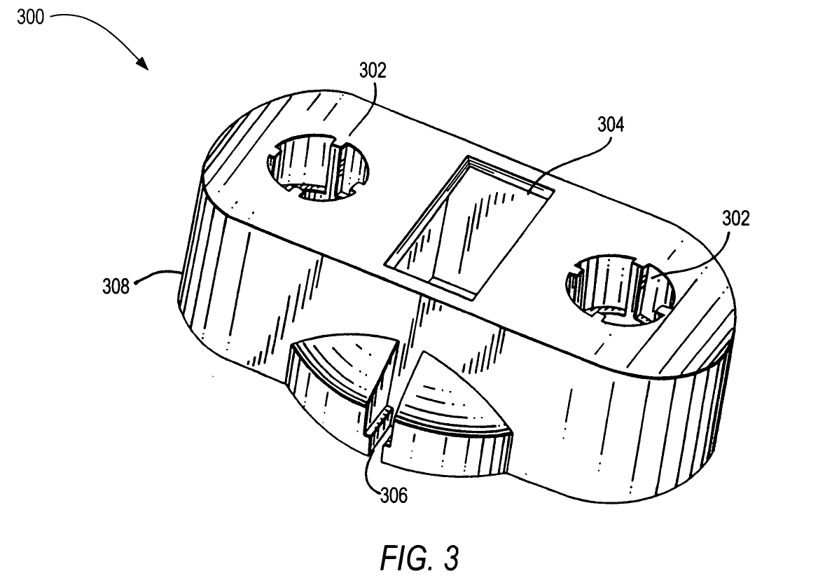

FIG. 3 is top perspective view of another embodiment of a lamp holder body 300 for receiving two lamp sockets and a GFCI receptacle in accordance with the present disclosure. The GFCI receptacle opening 304 can be positioned between the lamp socket openings 302. The lamp holder body may include an opening for a switch (not shown) as described above. The lamp sockets mounted in the lamp socket openings 302 can include a pull-chain switch. In an implementation, a separate switch (not shown) may be mounted in the switch opening to control flow of power to the lamp sockets and/or the GFCI receptacle. Alternatively, delivery of power to the lamp sockets and/or receptacle can be from a switch separate from the lamp sockets. The lamp holder body also can include two or more mounting portions 306 positioned to enable mounting of the lamp holder body to a single or double gang outlet box.

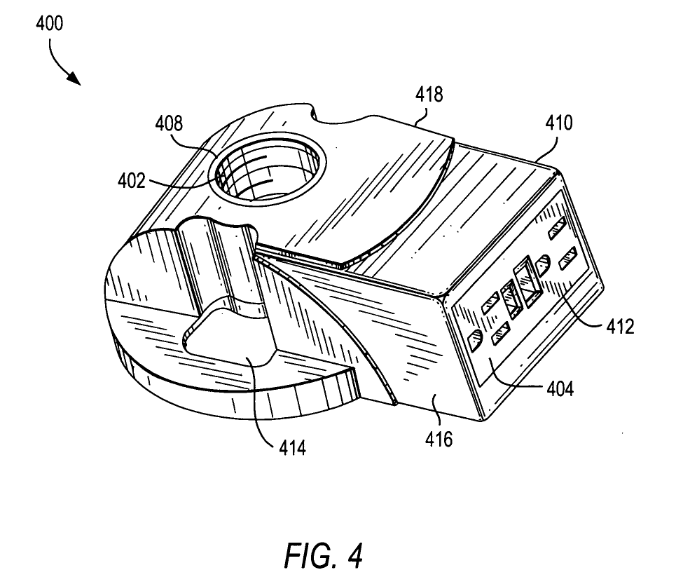

FIG. 4 illustrates a top perspective view of a lamp holder 400 having a lamp socket 408 and a GFCI receptacle 404 mounted in a lamp holder body 410. Lamp holder body 410 includes openings 402, 404 for receiving a lamp socket and a GFCI receptacle, respectively. The lamp socket 408 is mounted in lamp socket opening 402 and the GFCI receptacle 404 is mounted in receptacle opening 412. The receptacle 404 and lamp socket 402 are on different surfaces of the lamp holder body 410. In the embodiment illustrated, the GFCI receptacle 404 is mounted on a side of the lamp holder body 410 and the lamp socket is mounted on the top surface of the lamp holder body. A switch (not shown) can be mounted in the lamp holder body 410 to control delivery of power to the lamp socket 408 Power may be supplied to the lamp socket 408 independently of the GFCI receptacle 404. Alternatively, delivery of power to the lamp socket and/or the GFCI receptacle can be from a switch separate from the lamp holder 400. As described above, a back cover (not shown) made of an insulating material, such as plastic, can cover all or selected portions of the back of the lamp holder 400. The back cover can provide protection for wiring and electrical connections in portions of the lamp holder that extend past an outlet box (not shown) mounted in the wall. The lamp holder 400 can have mounting portions 414 to enable the lamp holder to be mounted to an outlet box by screws threaded into the outlet box or by other suitable means.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A lamp holder comprising:
a lamp holder body adapted to mount to an outlet box;
a lamp socket mounted in the lamp holder body; and
a ground fault circuit interrupter receptacle mounted in the lamp holder body,
wherein the ground fault circuit interrupter receptacle and the lamp socket are mounted in different surfaces of the lamp holder body.

2. The lamp holder of claim 1, wherein the lamp socket is mounted in a top surface of the lamp holder body and the ground fault circuit interrupter receptacle is mounted in a side surface of the lamp holder body.

3. The lamp holder of claim 1, wherein lamp socket includes a pull-chain switch.

4. The lamp holder of claim 1 comprising a cover to cover coupled to a bottom surface of the lamp holder body.

5. The lamp holder of claim 4, wherein the bottom cover is comprised of an electrically non-conducting material.

6. The lamp holder of claim 1 further comprising an occupancy sensor adapted to control delivery of power to the lamp socket.

7. The lamp holder of claim 1 further comprising a photoelectric sensor adapted to control delivery of power to the lamp socket.
